(19) United States
(12) Patent Application Publication
(10) Pub. No.: US 2012/0279652 A1
(43) Pub. Date: Nov. 8, 2012

(54) METHOD FOR PRODUCING METALLIC FOIL LAMINATE BODY

(75) Inventors: Shohei Azami, Tsukuba-shi (JP); Satoshi Okamoto, Tsukuba-shi (JP); Hironobu Iyama, Takatsuki-shi (JP)

(73) Assignee: SUMITOMO CHEMICAL COMPANY, LIMITED, Chuo-ku, Tokyo (JP)

(21) Appl. No.: 13/510,136

(22) PCT Filed: Nov. 15, 2010
(86) PCT No.: PCT/JP2010/070298

§ 371 Date: Jul. 27, 2012

(30) Foreign Application Priority Data
Nov. 16, 2009 (JP) 2009-260985

(51) Int. Cl. B32B 37/14

(52) U.S. Cl. 156/306.6

(57) ABSTRACT

Improved moisture absorption solder heat resistance is obtained in producing a metallic foil laminate body having a metal foil attached on both sides of a laminated base material including a plurality of insulating base materials. A laminated base material (2) is first prepared by pressurizing and integrating a plurality of insulating base materials (2a) in a prepressing step. Then, the laminated base material (2) is heat-treated. Thereafter, this laminated base material (2) is sandwiched between a pair of metal foils (3A) and (3B), and heated and pressurized to be integrated into a metallic foil laminate body. The prepressing step makes it possible to prevent an interface between the insulating base materials (2a) from being generated. As a result, swelling is not generated on the surfaces of the insulating base materials (2a).

### DESCRIPTION

1. Technical Field

The present invention relates to a method for producing a metallic foil laminate body to be used as a material for a printed wiring board, for example.

2. Background Art

Conventionally, since characteristics such as heat resistance, electrical characteristics, low moisture absorption property, and dimension stability are demanded for an insulating base material for such a metallic foil laminate body, a resin-impregnated base material in which a glass cloth is impregnated with a liquid crystal polyester has been proposed (see, e.g., Patent Literature 1).

### CITATION LIST

### Patent Literature

Patent Literature 1: Japanese Patent Application Laid-Open Publication No. 2007-146139

### SUMMARY OF INVENTION

### Technical Problem

However, in the case of a plurality of insulating base materials, when producing a metallic foil laminate body through a two-step process of a heat treatment step and a hot pressing step according to a production method disclosed in Patent Literature 1, swelling tends to easily occur on the surfaces of the insulating base materials with removing a metal foil by etching and then performing a moisture absorption solder heat resistance test. Namely, there has conventionally been a problem that, in the case of using the plurality of insulating base materials, the obtained laminate is poor in moisture absorption solder heat resistance.

Under such circumstances, an object of the present invention is to provide a method for producing a metallic foil laminate body that can obtain a metallic foil laminate body excellent in moisture absorption solder heat resistance even if using the plurality of insulating base materials.

### Solution to Problem

In order to achieve such an object, the present inventors have intensively studied, and have found that the reason why swelling easily occurs in the moisture absorption solder heat resistance test in the case of using the plurality of insulating base materials is considered to be due to the following that, during producing the metallic foil laminate body, a crystal structure of a liquid crystal polyester is organized in the heat treatment step and an interface is generated between the plurality of insulating base materials in the subsequent hot pressing step, thereby causing water to infiltrate into the interface at the time of moisture absorption after the completion of the metallic foil laminate body.

The present inventors have focused on producing the metallic foil laminate body through a three-step process of a prepressing step, a heat treatment step and a main pressing step in order to avoid the event that swelling occurs on the surfaces of the insulating base materials in the moisture absorption solder heat resistance test, and have led to complete the present invention.

Namely, a first feature of the present invention relates to a method for producing a metallic foil laminate body provided with a metal foil on both sides of a laminated base material including a plurality of insulating base materials, the method including a prepressing step of pressurizing and integrating a plurality of the insulating base materials in the state of being laminated to thereby prepare the laminated base material, a heat treatment step of heat-treating the laminated base material, and a main pressing step of sandwiching the laminated base material between a pair of metal foils, and heating, pressuring and integrating the laminated base material and the pair of metal foils to thereby produce a metallic foil laminate body.

According to a second feature of the present invention, in addition to the constitution of the first feature, the prepressing step and the main pressing step are carried out under reduced pressure.

According to a third feature of the present invention, in addition to the constitution of the first or second feature, the prepressing step includes pressurizing the plurality of insulating base materials sequentially sandwiched between a pair of mold release films, a pair of metal plates and a pair of cushion materials.

According to a fourth feature of the present invention, in addition to the constitution of the third feature, the mold release film is a polyimide film.

According to a fifth feature of the present invention, in addition to the constitution of the third or fourth feature, the metal plate is a SUS plate.

According to a sixth feature of the present invention, in addition to the constitution of any one of the third to fifth features, the cushion material is an aramid cushion.

According to a seventh feature of the present invention, in addition to the constitution of any one of the first to sixth features, the insulating base material is a resin-impregnated base material in which an inorganic fiber or a carbon fiber is impregnated with a thermoplastic resin.

According to an eighth feature of the present invention, in addition to the constitution of the seventh feature, the thermoplastic resin is a liquid crystal polyester having solubility in a solvent and a flow initiation temperature thereof is 250° C. or higher.

According to a ninth feature of the present invention, in addition to the constitution of the eighth feature, the liquid crystal polyester is a liquid crystal polyester that has a structural unit represented by Formula (1), a structural unit represented by (2) and a structural unit represented by Formula (3), wherein the content of the structural unit represented by Formula (1) is 30 to 45% by mole, the content of the structural unit represented by Formula (2) is 27.5 to 35% by mole, and the content of the structural unit represented by Formula (3) is 27.5 to 35% by mole, based on the total of all the structural units:

—O—Ar¹—CO— (1)

—CO—Ar²—CO— (2)

—X—Ar³—Y— (3)

(wherein Ar¹ represents a phenylene group or a naphthylene group, Ar² represents a phenylene group, a naphthylene group or a group represented by Formula (4), Ar³ represents a phenylene group or a group represented by Formula (4), and X and Y each independently represent O or NH, wherein hydrogen atoms bound to aromatic rings on Ar¹ , Ar² and Ar³ may be substituted with halogen atoms, alkyl groups or aryl groups.)

—Ar₁₁—Z—Ar¹²— (4)

(wherein Ar¹¹ and Ar¹² each independently represent a phenylene group or a naphthylene group, and Z represents O, CO or SO₂.).

According to a tenth feature of the present invention, in addition to the constitution of the ninth feature, at least one of X and Y in the structural unit shown by Formula (3) is NH.

According to an eleventh feature of the present invention, in addition to the constitution of any one of the eighth to tenth features, the liquid crystal polyester is a liquid crystal polyester in which the total content of a structural unit derived from p-hydroxybenzoic acid and a structural unit derived from 2-hydroxy-6-naphthoic acid is 30 to 45% by mole, the total content of a structural unit derived from terephthalic acid, a structural unit derived from isophthalic acid and a structural unit derived from 2,6-naphthalenedicarboxylic acid is 27.5 to 35% by mole, and the content of a structural unit derived from p-aminophenol is 27.5 to 35% by mole.

A twelfth feature of the present invention relates to a method for producing a metallic foil laminate body provided with a metal foil on both sides of a laminated base material including a plurality of insulating base materials, the method including a prepressing step of pressurizing a first laminated structure, in which a plurality of first laminates each having a plurality of the insulating base materials laminated are stacked in the laminating direction so that at least a first partition material is placed between the first laminates, in the laminating direction thereof to thereby prepare a second laminate in which a plurality of the laminated base materials each having a plurality of the insulating base materials integrated are stacked via the first partition material interposed therebetween, a heat treatment step of heat-treating the second laminate, and a main pressing step of heating and pressurizing a second laminated structure, in which a plurality of third laminates each sandwiching the laminated base material after the heat treatment step with a pair of the metal foils are stacked in the laminating direction so that at least a second partition material is placed between the third laminates, in the laminating direction thereof to thereby produce a plurality of metallic foil laminate bodies where the laminated base material is sandwiched between the pair of metal foils and integrated.

### Advantageous Effects of Invention

According to the present invention, a metallic foil laminate body is produced through a three-step process of a prepressing step, a heat treatment step and a main pressing step, thereby making it possible to previously adhere a plurality of insulating base materials to each other before heat-treating a laminated base material to thereby prevent the interface therebetween from being generated. As a result, it is possible to avoid the event that swelling occurs on the surfaces of the insulating base materials in the moisture absorption solder heat resistance test, thereby making it possible to obtain a metallic foil laminate body excellent in moisture absorption solder heat resistance.

### BRIEF DESCRIPTION OF DRAWINGS

FIG. 1 is a perspective view showing a metallic foil laminate body according to Embodiment 1.

FIG. 2 is a cross-section view showing the metallic foil laminate body according to Embodiment 1.

FIG. 3 is a schematic configuration view of a hot press apparatus according to Embodiment 1.

FIG. 4 is a cross-section view showing an aspect of a prepressing step in a method for producing a metallic foil laminate body according to Embodiment 1.

FIG. 5 is a graph exemplifying a temperature-pressure profile of the prepressing step in the method for producing a metallic foil laminate body according to Embodiment 1.

FIG. 6 is a cross-section view showing an aspect of a main pressing step in the method for producing a metallic foil laminate body according to Embodiment 1.

FIG. 7 is a graph exemplifying a temperature-pressure profile of the main pressing step in the method for producing a metallic foil laminate body according to Embodiment 1.

FIG. 8 is a cross-section view showing a prepressing step in a method for producing a metallic foil laminate body according to Embodiment 2.

FIG. 9 is a cross-section view showing an aspect of a main pressing step in the method for producing a metallic foil laminate body according to Embodiment 2.

FIG. 10 is a cross-section view showing an aspect of a main pressing step in a method for producing a metallic foil laminate body according to Embodiment 3.

FIG. 11 is a cross-section view showing an aspect of a main pressing step in a method for producing a metallic foil laminate body according to Embodiment 4.

### DESCRIPTION OF EMBODIMENTS

Hereinafter, preferred embodiments of the present invention will be described.

### Embodiment 1

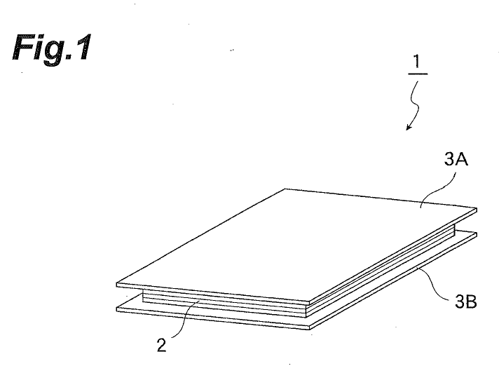

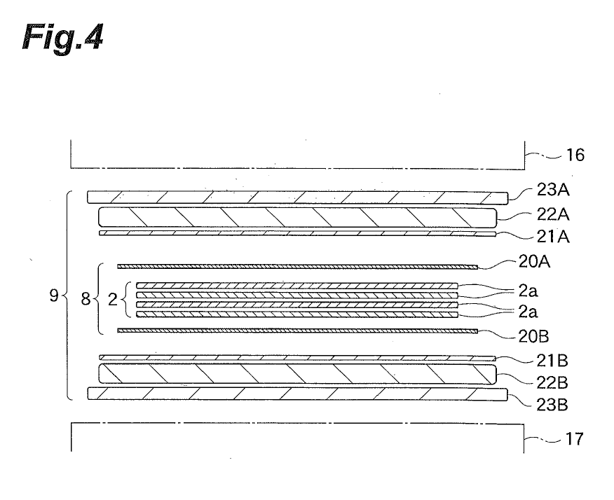

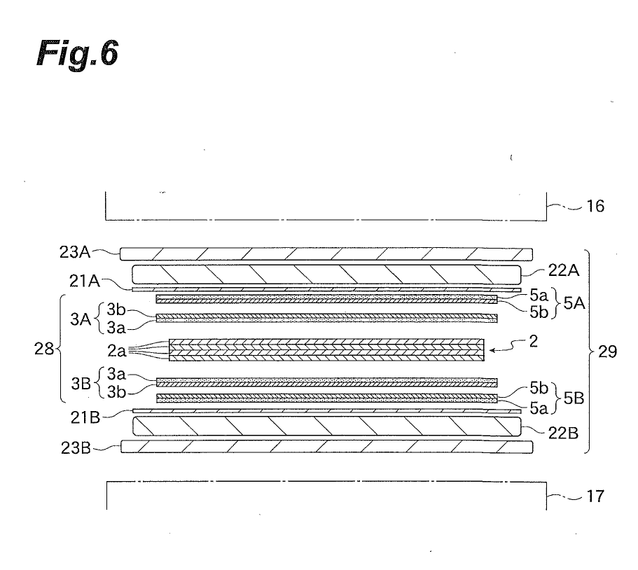

Embodiment 1 will be described with reference to FIG. 1 to FIG. 7. In Embodiment 1, a one-stage constitution, namely, a case where one metallic foil laminate body is produced by single hot pressing will be described. In FIG. 4 and FIG. 6, the respective members are illustrated with being separated from one another for easy understanding.

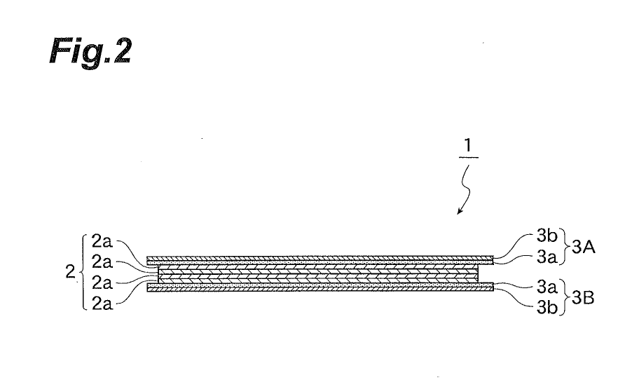

As shown in FIG. 1, a metallic foil laminate body 1 according to Embodiment 1 has a square plate-shaped laminated base material 2. The laminated base material 2 has a configuration in which four resin-impregnated base materials 2a are laminated, as shown in FIG. 2. The laminated base material 2 is integrally attached to square sheet-shaped copper foils 3 (3A, 3B) on both upper and lower surfaces thereof, respectively. Herein, as shown in FIG. 2, each of the copper foils 3 has a two-layered structure including a mat surface 3a and a shine surface 3b, and is in contact with the laminated base material 2 on the side of the mat surface 3a. The size of each of the copper foils 3 (one side of the square) is slightly larger than that of the laminated base material 2. In order to obtain a metallic foil laminate body 1 with satisfactory surface smoothness, it is desirable that the thickness of each of the copper foils 3 is 18 μm or more and 100 μm or less from the viewpoints of availability and ease of handling.

Herein, each of the resin-impregnated base materials 2a is a prepreg in which an inorganic fiber (preferably, a glass cloth) or a carbon fiber is impregnated with a liquid crystal polyester excellent in heat resistance and electrical characteristics. This liquid crystal polyester is a polyester having characteristics in which optical anisotropy is exhibited upon melting and an anisotropic melt is formed at a temperature of 450° C. or lower. The liquid crystal polyester is preferably a liquid crystal polyester having a structural unit shown by Formula (1) (hereinafter, referred to as a “structural unit of Formula (1)”), a structural unit shown by Formula (2) (hereinafter, referred to as a “structural unit of Formula (2)”) and a structural unit shown by Formula (3) (hereinafter, referred to as a “structural unit of Formula (3)”), wherein the content of the structural unit of Formula (1) is 30 to 45% by mole, the content of the structural unit of Formula (2) is 27.5 to 35% by mole, and the content of the structural unit of Formula (3) is 27.5 to 35% by mole, based on the total of all the structural units:

—O—Ar¹—CO— (1)

—CO—Ar²—CO— (2)

—X—Ar³—Y— (3)

(wherein Ar¹ represents a phenylene group or a naphthylene group, Ar² represents a phenylene group, a naphthylene group or a group represented by Formula (4), Ar³ represents a phenylene group or a group represented by Formula (4), and X and Y each independently represent O or NH, wherein hydrogen atoms bound to aromatic rings on Ar¹, Ar² and Ar³ may be substituted with halogen atoms, alkyl groups or aryl groups.)

—Ar₁₁—Z—Ar¹²— (4)

(wherein Ar¹¹ and Ar¹² each independently represent a phenylene group or a naphthylene group, and Z represents O, CO or SO₂.)

Herein, the structural unit of Formula (1) is a structural unit derived from an aromatic hydroxycarboxylic acid. Examples of the aromatic hydroxycarboxylic acid include p-hydroxybenzoic acid, m-hydroxybenzoic acid, 2-hydroxy-6-naphthoic acid, 2-hydroxy-3-naphthoic acid, and 1-hydroxy-4-naphthoic acid. The structural unit of Formula (1) may have multiple kinds of structural units. In this case, the total of these structural units corresponds to the proportion of the structural unit of Formula (1).

The structural unit of Formula (2) is a structural unit derived from an aromatic dicarboxylic acid. Examples of this aromatic dicarboxylic acid include terephthalic acid, isophthalic acid, 2,6-naphthalenedicarboxylic acid, 1,5-naphthalenedicarboxylic acid, diphenylether-4,4′-dicarboxylic acid, diphenylsulfone-4,4′-dicarboxylic acid, and diphenylketone-4,4′-dicarboxylic acid. The structural unit of Formula (2) may have multiple kinds of structural units. In this case, the total of these structural units corresponds to the proportion of the structural unit of Formula (2).

The structural unit of Formula (3) is a structural unit derived from an aromatic diol, an aromatic amine having a phenolic hydroxyl group, or an aromatic diamine. Examples of the aromatic diol include hydroquinone, resorcin, 2,2-bis(4-hydroxy-3,5-dimethylphenyl)propane, bis(4-hydroxyphenyl)ether, bis-(4-hydroxyphenyl)ketone, and bis-(4-hydroxyphenyl)sulfone. Examples of the aromatic amine having a phenolic hydroxyl group include p-aminophenol (4-aminophenol) and m-aminophenol (3-aminophenol). Examples of the aromatic diamine include 1,4-phenylenediamine and 1,3-phenylenediamine. The structural unit of Formula (3) may have multiple kinds of structural units. In this case, the total of these structural units corresponds to the proportion of the structural unit of Formula (3).

The liquid crystal polyester preferably has solubility in a solvent. Such solubility in a solvent means that the liquid crystal polyester is dissolved in a solvent in a concentration of 1% by mass or more at a temperature of 50° C. In this case, the solvent is any one of suitable solvents to be used for preparing a liquid composition described later, and will be described later in detail.

Such a liquid crystal polyester having solubility in a solvent is preferably one including, as the structural unit of Formula (3), a structural unit derived from an aromatic amine having a phenolic hydroxyl group and/or a structural unit derived from an aromatic diamine. That is, it is preferable to include, as the structural unit of Formula (3), a structural unit in which at least one of X and Y is NH (a structural unit shown by Formula (3′), hereinafter, referred to as a “structural unit of Formula (3′)”) since the liquid crystal polyester tends to be excellent in solubility in a suitable solvent described later (aprotic polar solvent). It is particularly preferable that substantially all the structural units of Formula (3) be the structural units of Formula (3′) from the viewpoint of obtaining excellent solubility in a solvent. The structural unit of Formula (3′) has advantages of making solubility of the liquid crystal polyester in a solvent sufficient and also lowering water absorbability of the liquid crystal polyester:

—X—Ar³—NH— (3′)

(wherein Ar³ and X have the same meanings as in Formula (3).)

It is more preferable to include the structural unit of Formula (3) within a range from 30 to 32.5% by mole based on the total of all the structural units. This makes solubility in a solvent more favorable. The liquid crystal polyester having the structural unit of Formula (3′) as the structural unit of Formula (3) has also an advantage of more easily producing the resin-impregnated base material 2a using a liquid composition described later, in addition to the advantages in terms of solubility in a solvent and low water absorbability.

The structural unit of Formula (1) is preferably included within a range from 30 to 45% by mole, and more preferably within a range from 35 to 40% by mole, based on the total of all the structural units. The liquid crystal polyester including the structural unit of Formula (1) in such a mole fraction tends to be more excellent in solubility in a solvent while sufficiently maintaining liquid crystallinity. Furthermore, if considering together availability of an aromatic hydroxycarboxylic acid, from which the structural unit of Formula (1) is derived, p-hydroxybenzoic acid and/or 2-hydroxy-6-naphthoic acid are/is suitable as this aromatic hydroxycarboxylic acid.

The structural unit of Formula (2) is preferably included within a range from 27.5 to 35% by mole, and more preferably within a range from 30 to 32.5% by mole, based on the total of all the structural units. The liquid crystal polyester including the structural unit of Formula (2) in such a mole fraction tends to be more excellent in solubility in a solvent while sufficiently maintaining liquid crystallinity. Furthermore, if considering together availability of an aromatic dicarboxylic acid, from which the structural unit of Formula (2) is derived, at least one selected from the group consisting of terephthalic acid, isophthalic acid and 2,6-naphthalenedicarboxylic acid is preferable as this aromatic dicarboxylic acid.

In order that the obtained liquid crystal ester easily exerts a higher liquid crystallinity, the mole fraction of the structural unit of Formula (2) to the structural unit of Formula (3), represented by [structural unit of Formula (2)]/[structural unit of Formula (3)], is suitably within a range from 0.9/1 to 1/0.9.

Next, examples of a method for producing a liquid crystal polyester will be described.

The liquid crystal polyester can be produced by various known methods. In the case where a suitable liquid crystal polyester, namely, the liquid crystal polyester including the structural unit of Formula (1), the structural unit of Formula (2) and structural unit of Formula (3) is produced, a method for producing a liquid crystal polyester by converting a monomer, from which these structural units are derived, into an ester-forming and amide-forming derivative and then polymerizing the derivative is preferable because the operation thereof is simple.

This ester-forming and amide-forming derivative will be described by way of examples.

Examples of the ester-forming and amide-forming derivative of a monomer having a carboxyl group, such as an aromatic hydroxycarboxylic acid or an aromatic dicarboxylic acid, include the following, namely, those in which the carboxyl group is a group with a high reaction activity, such as an acid chloride or an acid anhydride, so as to promote a reaction of producing a polyester or a polyamide, and those in which the carboxyl group forms an ester with alcohols, ethylene glycol or the like so as to produce a polyester or a polyamide by an ester exchange and amide exchange reaction.

Examples of the ester-forming and amide-forming derivative of a monomer having a phenolic hydroxyl group, such as an aromatic hydroxycarboxylic acid or an aromatic diol, include those in which the phenolic hydroxyl group forms an ester with carboxylic acids so as to produce a polyester or a polyamide by an ester exchange reaction.

Examples of the amide-forming derivative of a monomer having an amino group, such as an aromatic diamine, include those in which the amino group forms an amide with carboxylic acids so as to produce a polyamide by an amide exchange reaction.

Among them, from the viewpoint of producing a liquid crystal polyester more simply, particularly preferable is the following method: first, an aromatic hydroxycarboxylic acid, and a monomer having a phenolic hydroxyl group and/or an amino group, such as an aromatic diol, an aromatic amine having a phenolic hydroxyl group, or an aromatic diamine, are acylated with a fatty acid anhydride to form an ester-forming and amide-forming derivative (acylate); and then, the acylate is polymerized so that an acyl group of the acylate and a carboxylic group of a monomer having a carboxylic group lead to ester exchange and amide exchange, to thereby produce a liquid crystal polyester.

Such a method for producing a liquid crystal polyester is disclosed in, for example, Japanese Patent Application Laid-Open Publication No. 2002-220444 or Japanese Patent Application Laid-Open Publication No. 2002-146003.

In the acylation, the amount of the fatty acid anhydride to be added is preferably from 1 to 1.2-fold equivalent, and more preferably from 1.05 to 1.1-fold equivalent, based on the total of the phenolic hydroxyl group and the amino group. If the amount of the fatty acid anhydride to be added is less than 1-fold equivalent, there is a tendency that the acylate and a raw monomer are sublimated upon polymerization to easily cause clogging of a reaction system. In contrast, if it is more than 1.2-fold equivalent, there is a tendency that the liquid crystal polyester to be obtained is remarkably colored.

The acylation is preferably carried out at 130 to 180° C. for 5 minutes to 10 hours, and more preferably carried out at 140 to 160° C. for 10 minutes to 3 hours.

The fatty acid anhydride to be used for the acylation is preferably acetic anhydride, propionic anhydride, butyric anhydride, isobutyric anhydride or a mixture of two or more selected therefrom, from the viewpoints of price and handling properties. The fatty acid anhydride is particularly preferably acetic anhydride.

The polymerization which follows the acylation is preferably carried out while raising the temperature from 130 to 400° C. at a rate of 0.1 to 50° C./minute, and more preferably carried out while raising the temperature from 150 to 350° C. at a rate of 0.3 to 5° C./minute.

In the polymerization, the amount of the acyl group in the acylate is preferably 0.8 to 1.2-fold equivalent based on that of the carboxyl group.

In the case of the acylation and/or polymerization, a fatty acid and an unreacted fatty acid anhydride to be produced as by-products are preferably distilled out of the system by evaporation or the like so as to shift equilibrium by Le Chatelier-Braun principle (principle of mobile equilibrium).

It is to be noted that the acylation and polymerization may be carried out in the presence of a catalyst. It is possible to use, as this catalyst, one which has been conventionally known as a catalyst for polymerization of a polyester. Examples include metal salt catalysts such as magnesium acetate, stannous acetate, tetrabutyl titanate, lead acetate, sodium acetate, potassium acetate, and antimony trioxide; and organic compound catalysts such as N,N-dimethylaminopyridine and N-methylimidazole.

Among these catalysts, a heterocyclic compound including two or more nitrogen atoms, such as N,N-dimethylaminopyridine or N-methylimidazole is preferably used (see Japanese Patent Application Laid-Open Publication No. 2002-146003).

This catalyst is usually simultaneously charged when a monomer is charged, and it is not necessarily required to be removed after the acylation. In the case where this catalyst is not removed, the acylation can be shifted to the polymerization as it is.

The liquid crystal polyester obtained in such polymerization can be used as it is in the present embodiment, but it is preferable, in order to further improve characteristics such as heat resistance and liquid crystallinity, to increase the molecular weight. Solid phase polymerization is preferably carried out so as to achieve such an increase in molecular weight. A series of operations according to this solid phase polymerization will be described below. The liquid crystal polyester with a comparatively low molecular weight obtained by the above polymerization is taken out and ground into a powder or flake. Subsequently, the liquid crystal polyester after grinding is subjected to a heat treatment under an atmosphere of an inert gas such as nitrogen at 20 to 350° C. for 1 to 30 hours in a solid phase state, for example.

These operations can allow the solid phase polymerization to be performed. This solid phase polymerization may be carried out with stirring, or may be carried out in a state of being left to stand without stirring. Here, from the viewpoint of obtaining a liquid crystal polyester with a suitable flow initiation temperature described later, the details of suitable conditions of this solid phase polymerization are as follows: the reaction temperature is preferably higher than 210° C., and more preferably within a range from 220 to 350° C., and the reaction time is preferably selected from 1 to 10 hours.

In the liquid crystal polyester to be used in the present embodiment, the flow initiation temperature is preferably 250° C. or higher in that a higher adhesion is obtained between a conductor layer to be formed on the laminated base material 2 and an insulating layer (laminated base material 2). The flow initiation temperature herein refers to a temperature at which a melt viscosity of a liquid crystal polyester is 4800 Pa·s or less under a pressure of 9.8 MPa in the evaluation of melt viscosity with a flow tester. It is to be noted that this flow initiation temperature is well known to a person with an ordinary skill in the art as an indication of the molecular weight of the liquid crystal polyester (see, for example, edited by Naoyuki Koide, “Synthesis, Forming and Application of Liquid Crystal Polymer”, pp. 95-105, CMC, issued on Jun. 5, 1987).

The flow initiation temperature of the liquid crystal polyester is more preferably 250° C. or higher and 300° C. or lower. If the flow initiation temperature is 300° C. or lower, the solubility in a solvent of the liquid crystal polyester is made more favorable and also the viscosity thereof does not remarkably increase when a liquid composition described later is obtained, and therefore, the handling properties of this liquid composition tends to be made favorable. From such a viewpoint, a liquid crystal polyester in which a flow initiation temperature thereof is 260° C. or higher and 290° C. or lower is more preferable. Here, in order to control the flow initiation temperature of the liquid crystal polyester within such a suitable range, the polymerization conditions of the solid phase polymerization may be appropriately optimized.

Herein, it is preferable for obtaining the resin-impregnated base material 2a to use a liquid composition including a liquid crystal polyester and a solvent, in particular, a liquid composition in which a liquid crystal polyester is dissolved therein.

In the case where the above-described suitable liquid crystal polyester, in particular, the liquid crystal polyester including the above-described structural unit of Formula (3′) is used as the liquid crystal polyester to be used in the present embodiment, this liquid crystal polyester can exert sufficient solubility in an aprotic solvent including no halogen atom.

Examples of the aprotic solvent including no halogen atom include ether-based solvents such as diethylether, tetrahydrofuran, and 1,4-dioxane; ketone-based solvents such as acetone and cyclohexanone; ester-based solvents such as ethyl acetate; lactone-based solvents such as γ-butyrolactone; carbonate-based solvents such as ethylene carbonate and propylene carbonate; amine-based solvents such as triethylamine and pyridine; nitrile-based solvents such as acetonitrile and succinonitrile; amide-based solvents such as N,N-dimethylformamide, N,N-dimethylacetamide, tetramethylurea, and N-methyl pyrrolidone; nitro-based solvents such as nitromethane and nitrobenzene; sulfur-based solvents such as dimethyl sulfoxide and sulfolane; and phosphorous-based solvents such as hexamethylphosphoric acid amide and tri-n-butylphosphoric acid. It is to be noted that the above-described solubility in a solvent of the liquid crystal polyester refers to solubility in at least one aprotic solvent selected from these solvents.

From the viewpoint of making the solubility in a solvent of the liquid crystal polyester more favorable to thereby easily obtain a liquid composition, it is preferable to use an aprotic polar solvent in which a dipole moment thereof is 3 or more and 5 or less among the exemplified solvents. Specifically, it is preferable to use an amide-based solvent or a lactone-based solvent, and it is more preferable to use N,N′-dimethylformamide (DMF), N,N′-dimethylacetamide (DMAc) or N-methylpyrrolidone (NMP). Furthermore, when the solvent is a high volatility solvent in which a boiling point thereof is 180° C. or lower at 1 atm, there is an advantage that it is easy to remove the solvent after impregnating an inorganic fiber or a carbon fiber with a liquid composition. From this viewpoint, DMF and DMAc are particularly preferable. The use of such an amide-based solvent also has an advantage that thickness unevenness or the like is less likely caused in the production of the resin-impregnated base material 2a to thereby easily form a conductor layer on this resin-impregnated base material 2a.

When the above-described aprotic solvent is used in the liquid composition, the liquid crystal polyester is preferably dissolved in an amount of 20 to 50 parts by mass, and preferably 22 to 40 parts by mass, based on 100 parts by mass of this aprotic solvent. When the content of the liquid crystal polyester in the liquid composition is within such a range, efficiency of impregnating the inorganic fiber or the carbon fiber with the liquid composition is made favorable in the production of the resin-impregnated base material 2a, and thus there is a tendency of hardly causing a disadvantage that thickness unevenness or the like is caused when the solvent is removed by drying after the impregnation.

As long as the object of the present invention is not impaired, to the liquid composition may be added one or two or more resins other than the liquid crystal polyester, for example, thermoplastic resins such as polypropylene, polyamide, polyester, polyphenylene sulfide, polyetherketone, polycarbonate, polyethersulfone, polyphenylether and a modified product thereof, and polyetherimide; elastomers typified by a copolymer of glycidyl methacrylate and polyethylene; and thermosetting resins such as a phenol resin, an epoxy resin, a polyimide resin, and a cyanate resin. However, when such other resins are used, these resins are also preferably soluble in the solvent to be used in the liquid composition.

Furthermore, as long as the effects of the present invention are not impaired, to the liquid composition may be added one or two or more kinds of various additives, for example, inorganic fillers such as silica, alumina, titanium oxide, barium titanate, strontium titanate, aluminum hydroxide, and calcium carbonate; organic fillers such as a cured epoxy resin, a crosslinked benzoguanamine resin, and a crosslinked acrylic polymer; silane coupling agents, antioxidants, and ultraviolet absorbers; for the purpose of improvements in dimension stability, pyroconductivity and electrical characteristics.

The liquid composition may be optionally subjected to a filtration treatment using a filter or the like to remove fine foreign matters included in the solution. The liquid composition may also be optionally subjected to a defoaming treatment.

The base material to be impregnated with the liquid crystal polyester to be used in the present embodiment is preferably one including an inorganic fiber and/or a carbon fiber. Here, the inorganic fiber is a ceramic fiber typified by glass, and examples thereof include a glass fiber, an alumina-based fiber, and a silicon-containing ceramic-based fiber. Among them, a sheet mainly including a glass fiber, namely, a glass cloth is preferable because of favorable availability.

The glass cloth is preferably one including an alkali-containing glass fiber, a non-alkali glass fiber or a low dielectric glass fiber. The glass cloth may also be partially mixed with, as a fiber constituting the glass cloth, a ceramic fiber including ceramic other than glass or a carbon fiber. The fiber constituting the glass cloth may be subjected to a surface treatment with a coupling agent such as an aminosilane-based coupling agent, an epoxysilane-based coupling agent or a titanate-based coupling agent.

Examples of a method for producing the glass cloth including these fibers can include a method in which fibers forming a glass cloth are dispersed in water and, if necessary, a sizing agent such as an acrylic resin is added thereto, and the resultant is subjected to sheet making with a paper machine and dried to obtain a nonwoven fabric; and a method using a known weaving machine.

A method for weaving fibers that can be utilized includes a plain weaving method, a satin weaving method, a twill weaving method, and a mat weaving method. The glass cloth in which a weave density is 10 to 100 fibers/25 mm and a mass per unit area is 10 to 300 g/m² is preferably used. The thickness of the glass cloth is preferably from about 10 to 200 μm, and more preferably from 10 to 180 μm.

A glass cloth which is easily available from the market can also be used as the base material. As such a glass cloth, various products are commercially available as an insulating impregnated base material for electronic components, and they are available from Asahi-Schwebel Co., Ltd., Nitto Boseki Co., Ltd., Arisawa Manufacturing Co., Ltd. and the like. Examples of the commercially available glass cloth with a suitable thickness include those having IPC names of 1035, 1078, 2116 and 7628.

The resin-impregnated base material 2a is particularly preferably one obtained by impregnating the inorganic fiber (preferably, glass cloth) or the carbon fiber with the liquid composition including a liquid crystal polyester and a solvent (in particular, liquid composition in which a liquid crystal polyester is dissolved in a solvent), and then removing the solvent by drying. The amount of the liquid crystal polyester adhered to the resin-impregnated base material 2a after removing the solvent is preferably 30 to 80% by mass, and more preferably 40 to 70% by mass, based on the mass of the obtained resin-impregnated base material 2a.

The suitable glass cloth as the inorganic fiber can be typically impregnated with the liquid composition by preparing a dipping bath in which this liquid composition is charged, and dipping the glass cloth in this dipping bath. Here, if the content of the liquid crystal polyester in the liquid composition used, the time of dipping in the dipping bath, and the pull-up rate of the glass cloth impregnated with the liquid composition are appropriately optimized, the amount of the above-described suitable liquid crystal polyester adhered can be easily controlled.

Thus, the resin-impregnated base material 2 can be produced by removing the solvent from the glass cloth impregnated with the liquid composition. A method for removing the solvent is not particularly limited, but it is preferably carried out by evaporating the solvent from the viewpoint of a simple operation, and for such evaporation is used a heating method, a reduced-pressure method, a ventilation method or a method of a combination thereof.

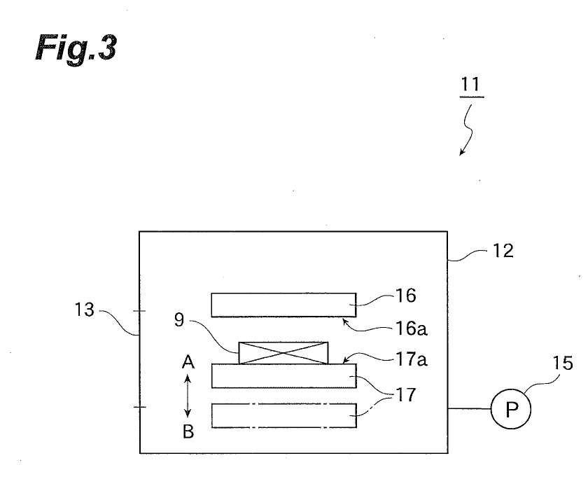

Herein, a hot press apparatus for producing the metallic foil laminate body 1 having the configuration described above will be described. A hot press apparatus 11 has, as shown in FIG. 3, a rectangular solid chamber 12, and a door 13 is attached onto the side (left side in FIG. 3) of the chamber 12 in an openable and closable manner. A vacuum pump 15 is connected to the chamber 12 so that the pressure in the chamber 12 can be reduced to a predetermined pressure (preferably, a pressure of 2 kPa or less). Furthermore, a pair of upper and lower hot platens (an upper hot platen 16 and a lower hot platen 17) are disposed opposite each other in the chamber 12. Here, the upper hot platen 16 is fixed to the chamber 12 so as not to ascend and descend, while the lower hot platen 17 is provided in an ascendible and descendible manner in the direction of arrow A-B to the upper hot platen 16. A pressure surface 16a is formed on the lower surface of the upper hot platen 16, while a pressure surface 17a is formed on the upper surface of the lower hot platen 17.

The metallic foil laminate body 1 can be produced by the following procedure using this hot press apparatus 11.

First, in the prepressing step, as shown in FIG. 4, a laminated base material 2 is prepared by pressurizing and integrating four resin-impregnated base materials 2a in the state of being laminated.

In order that, the four resin-impregnated base materials 2a are laminated in the vertical direction and are sandwiched between a pair of polyimide films 20A and 20B on both the upper and lower sides thereof to thereby prepare a first laminate 8 including the four resin-impregnated base materials 2a and the pair of polyimide films 20A and 20B. Then, the first laminate 8 is sequentially sandwiched between a pair of SUS plates 21A and 21B, a pair of SUS plates 22A and 22B, and a pair of aramid cushions 23A and 23B on both the upper and lower sides, to thereby prepare a second laminate 9 including the first laminate 8, the pair of SUS plates 21A and 21B, the pair of SUS plates 22A and 22B and the pair of aramid cushions 23A and 23B.

Herein, in the prepressing step, the second laminate 9 may be prepared in one step not by preparing the second laminate 9 followed by the preparation of the first laminate 8, but by collectively laminating the respective layers constituting the second laminate 9. In this prepressing step, for example, the pair of SUS plates 21 each with a thickness of 1 mm (21A and 21B), the pair of SUS plates 22 each with a thickness of 5 mm (22A and 22B) and the pair of aramid cushions 23 each with a thickness of 3 mm (23A and 23B) can be used.

In the prepressing step, with the hot press apparatus 11, the second laminate 9 is heated and pressurized in the laminating direction thereof (vertical direction in FIG. 4), thereby being integrated. That is, in the hot press apparatus 11 shown in FIG. 3, the door 13 is first opened, and the second laminate 9 is disposed on the pressure surface 17a of the lower hot platen 17. Then, the door 13 is closed and the vacuum pump 15 is driven, thereby reducing the pressure in the chamber 12 to a predetermined pressure. In this state, the lower hot platen 17 is appropriately ascended in the direction of arrow A, and thus the second laminate 9 is fixed with being softly sandwiched between the upper hot platen 16 and the lower hot platen 17. Then, the temperature of the upper hot platen 16 and the lower hot platen 17 is raised.

After the temperature is raised to a predetermined temperature, the lower hot platen 17 is further ascended in the direction of arrow A to thereby pressurize the second laminate 9 between the upper hot platen 16 and the lower hot platen 17. Thus, the four resin-impregnated base materials 2a in the second laminate 9 are prepressed. Therefore, the laminated base material 2 is formed between the upper hot platen 16 and the lower hot platen 17.

In the prepressing step, it is desirable that the treatment temperature be a temperature lower than the glass transition temperature of the liquid crystal polyester by 20 to 60° C. (namely, about 140 to 180° C.). The pressure of the prepressing is selected from 1 to 30 MPa, and the treatment time of the prepressing is selected from 10 minutes to 30 hours. Herein, in the prepressing step, in the case where the resin-impregnated base materials 2a are sufficiently integrated only by pressurizing, they do not necessarily have to be heated. However, by the heating, the generation of the interface between the resin-impregnated base materials 2a tends to be effectively suppressed.

Such prepressing of the four resin-impregnated base materials 2a allows the four resin-impregnated base materials 2a to be adhered to each other, thereby leading to the state where the interface is not generated between these resin-impregnated base materials 2a.

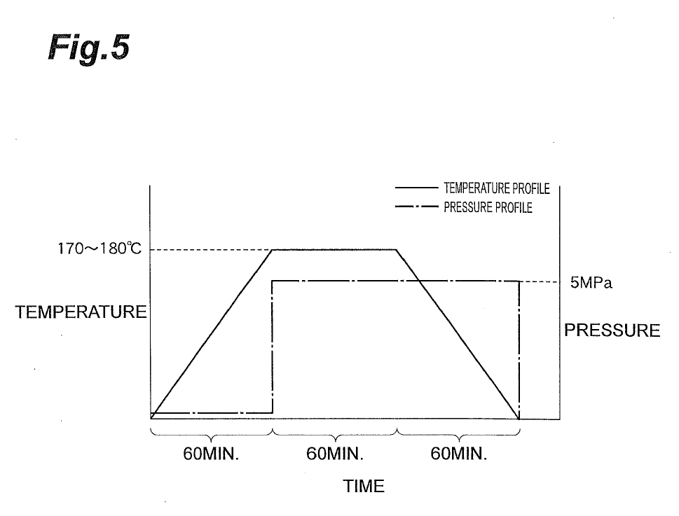

One example of the temperature-pressure profile in the prepressing step is shown in FIG. 5. In the graph in FIG. 5, the abscissa expresses a time, the ordinate on the left side expresses a temperature, and the ordinate on the right side expresses a pressure. The graph by the solid line expresses the temperature profile, and the graph by the dashed line expresses the pressure profile. That is, in the temperature-pressure profile shown in FIG. 5, the treatment temperature of the prepressing is raised from normal temperature to 170 to 180° C. at a constant rate over 60 minutes, then held at that temperature over 60 minutes, and lowered from that temperature to normal temperature at a constant rate over 60 minutes. The pressure of the prepressing is held at atmospheric pressure over 60 minutes, and then held at 5 MPa over 120 minutes.

Thereafter, the lower hot platen 17 is appropriately descended in the direction of arrow B, thereby leading to the state where the second laminate 9 is softly sandwiched between the upper hot platen 16 and the lower hot platen 17. Then, the reduced pressure state in the chamber 12 is released and also the lower hot platen 17 is further descended in the direction of arrow B, thereby keeping the second laminate 9 away from the pressure surface 16a of the upper hot platen 16. Finally, the door 13 is opened and the second laminate 9 is taken out from the interior of the chamber 12.

After the second laminate 9 is thus taken out, the polyimide films 20A and 20B, the SUS plates 21A and 21B, the SUS plates 22A and 22B, and the aramid cushions 23A and 23B are taken out from the second laminate 9, and only the laminated base material 2 is separated. At this time, each polyimide film 20 is interposed between the laminated base material 2 and the pair of SUS plates 21A and 21B, thereby making it possible to easily perform an operation of separating the laminated base material 2.

Then, after the laminated base material 2 is thus prepared, the prepressing step is shifted to the heat treatment step. In the heat treatment step, in order to further increase the molecular weight of the liquid crystal polyester included in the resin-impregnated base material 2a of the laminated base material 2, this laminated base material 2 is heat-treated. Examples of the condition of the heat treatment include a condition that the heat treatment is performed under an atmosphere of an inert gas such as nitrogen at 240 to 330° C. over 1 to 30 hours. Herein, from the viewpoint of obtaining a metallic foil laminate body having more favorable heat resistance, the heating temperature as the treatment condition of this heat treatment is preferably higher than 250° C., and the heating temperature is more preferably within a range from 260 to 320° C. It is preferable in terms of productivity that the treatment time of this heat treatment be selected from 1 to 10 hours.

After the laminated base material 2 is heat-treated, the heat treatment step is then shifted to the main pressing step. In the main pressing step, as shown in FIG. 6, the laminated base material 2 is sandwiched between the pair of copper foils 3A and 3B to be heated, pressurized and then integrated, thereby producing the metallic foil laminate body 1.

In the main pressing step, as shown in FIG. 6, in addition to the laminated base material 2 and the pair of copper foils 3A and 3B, a pair of spacer copper foils 5 (5A, 5B), the pair of SUS plates 21 each with a thickness of 1 mm (21A and 21B), the pair of SUS plates 22 each with a thickness of 5 mm (22A and 22B) and the pair of aramid cushions 23 each with a thickness of 3 mm (23A and 23B) can be used. Herein, each spacer copper foil 5 is provided with a two-layered structure including a mat surface 5a and a shine surface 5b.

In such a main pressing step, first, the laminated base material 2 is sandwiched between the pair of copper foils 3A and 3B on both the upper and lower sides. At this time, the mat surface 3a of each copper foil 3 is allowed to face towards the inside (side of the laminated base material 2). Then, these copper foils 3A and 3B are sandwiched between the pair of spacer copper foils 5A and 5B. At this time, the shine surface 5b of each spacer copper foil 5 is allowed to face towards the inside (side of the copper foil 3). Thereby, a third laminate 28 including the laminated base material 2, the pair of copper foils 3A and 3B and the pair of spacer copper foils 5A and 5B is obtained. Then, the third laminate 28 is sequentially sandwiched between the pair of SUS plates 21A and 21B, the pair of SUS plates 22A and 22B and the pair of aramid cushions 23A and 23B on both the upper and lower sides, thereby preparing a fourth laminate 29 including the third laminate 28, the pair of SUS plates 21A and 21B, the pair of SUS plates 22A and 22B and the pair of aramid cushions 23A and 23B.

Herein, also in the main pressing step, the fourth laminate 29 may be prepared in one step like in the prepressing step, not by preparing the fourth laminate 29 followed by the preparation of the third laminate 28, but by collectively laminating the respective layers constituting the fourth laminate 9.

Then, with the hot press apparatus 11, the fourth laminate 29 is heated and pressurized in the laminating direction thereof (vertical direction in FIG. 6), thereby being integrated. Thus, the metallic foil laminate body 1 including the laminated base material 2 and the pair of copper foils 3A and 3B is produced. That is, in the hot press apparatus 11 shown in FIG. 3, the door 13 is first opened, and the fourth laminate 29 is disposed on the pressure surface 17a of the lower hot platen 17. Then, the door 13 is closed and the vacuum pump 15 is driven, thereby reducing the pressure in the chamber 12 to a predetermined pressure. In this state, the lower hot platen 17 is appropriately ascended in the direction of arrow A, and thus the fourth laminate 29 is fixed with being softly sandwiched between the upper hot platen 16 and the lower hot platen 17. Then, the temperature of the upper hot platen 16 and the lower hot platen 17 is raised.

After the temperature is raised to a predetermined temperature, the lower hot platen 17 is further ascended in the direction of arrow A to thereby pressurize the fourth laminate 29 between the upper hot platen 16 and the lower hot platen 17. Thus, the four resin-impregnated base materials 2a in the fourth laminate 29 are mainly pressed. Therefore, the metallic foil laminate body 1 is formed between the upper hot platen 16 and the lower hot platen 17.

At this time, in the third laminate 28, the mat surface 3a of each copper foil 3 is in contact with the laminated base material 2, and thus the pair of copper foils 3A and 3B is strongly fixed to the laminated base material 2 by an anchor effect.

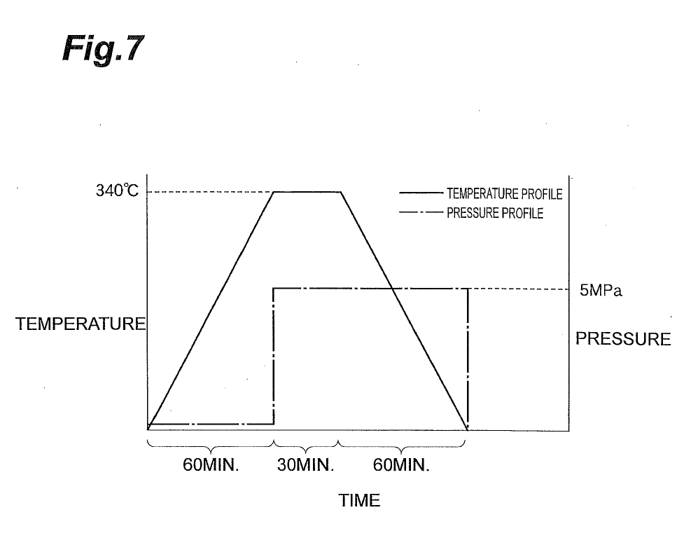

One example of the temperature-pressure profile in this main pressing step is shown in FIG. 7. In the graph in FIG. 7, the abscissa expresses a time, the ordinate on the left side expresses a temperature, and the ordinate on the right side expresses a pressure. The graph by the solid line expresses the temperature profile, and the graph by the dashed line expresses the pressure profile. That is, in the temperature-pressure profile shown in FIG. 7, the treatment temperature of the main pressing is raised from normal temperature to 340° C. at a constant rate over 60 minutes, then held at that temperature over 30 minutes, and lowered from that temperature to normal temperature at a constant rate over 60 minutes. The pressure of the main pressing is held at atmospheric pressure over 60 minutes, and then held at 5 MPa over 120 minutes.

Thereafter, the lower hot platen 17 is appropriately descended in the direction of arrow B, thereby leading to the state where the fourth laminate 29 is softly sandwiched between the upper hot platen 16 and the lower hot platen 17. Then, the reduced pressure state in the chamber 12 is released and also the lower hot platen 17 is further descended in the direction of arrow B, thereby keeping the fourth laminate 29 away from the pressure surface 16a of the upper hot platen 16. Finally, the door 13 is opened and the fourth laminate 29 is taken out from the interior of the chamber 12.

After the fourth laminate 29 is thus taken out, the spacer copper foils 5A and 5B, the SUS plates 21A and 21B, the SUS plates 22A and 22B and the aramid cushions 23A and 23B are taken out from the fourth laminate 29, and they are separated from the metallic foil laminate body 1. At this time, since the shine surface 3b of each copper foil 3 is in contact with the shine surface 5b of each spacer copper foil 5, each spacer copper foil 5 can be peeled from each copper foil 3, thereby making it possible to easily perform an operation of separating the metallic foil laminate body 1.

Thus, the production procedure of the metallic foil laminate body 1 is completed, thereby obtaining the metallic foil laminate body 1 in which the laminated base material 2 including the four resin-impregnated base materials 2a is attached to the pair of copper foils 3A and 3B on both sides thereof.

The thus obtained metallic foil laminate body 1 is in the state where the interface is not formed between the four resin-impregnated base materials 2a by the prepressing step, as described above. Therefore, it is possible to avoid the event that swelling occurs on the surface of the resin-impregnated base materials 2a even if the moisture absorption solder heat resistance test is performed after the completion of the metallic foil laminate body 1. Therefore, it is possible to obtain the metallic foil laminate body 1 excellent in moisture absorption solder heat resistance.

### Embodiment 2

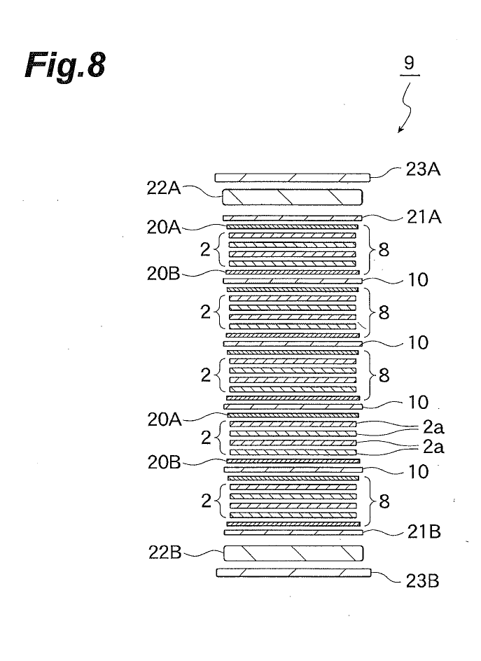

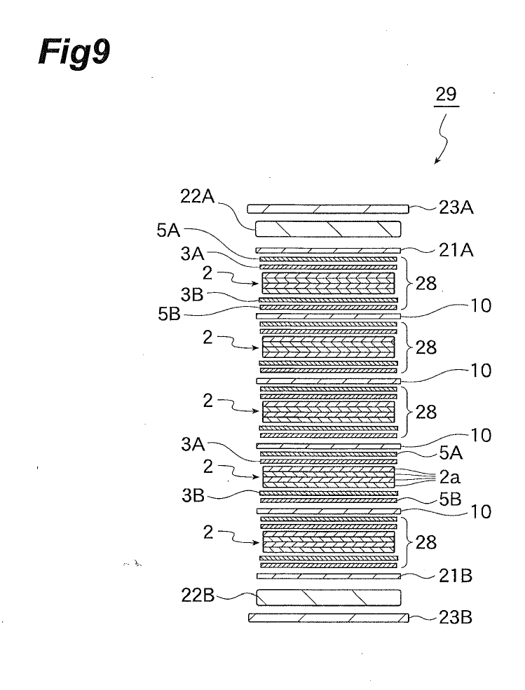

Embodiment 2 will be described with reference to FIG. 8 and FIG. 9. In Embodiment 2, a five-stage constitution, namely a case where five metallic foil laminate bodies are produced by single hot pressing will be described. In FIG. 8 and FIG. 9, the respective members are illustrated with being separated from one another for easy understanding.

A metallic foil laminate body 1 and a hot press apparatus 11 according to Embodiment 2 each have the same constitution as in Embodiment 1 described above.

When the hot press apparatus 11 is used to produce the metallic foil laminate body 1, five metallic foil laminate bodies 1 are simultaneously produced, as described below, according to the production procedure of the metallic foil laminate body 1 in Embodiment 1 described above.

First, in the prepressing step, five laminated base materials 2, each in which four resin-impregnated base materials 2a are laminated and integrated, are prepared, as shown in FIG. 8, according to the same procedure as in Embodiment 1 described above. Namely, five first laminates 8, each in which the four resin-impregnated base materials 2a are laminated and sandwiched between a pair of polyimide films (first partition material) 20A and 20B, are prepared. Then, the five first laminates 8 are stacked via a partition plate 10 such as a SUS plate with a thickness of 1 mm interposed therebetween, in the laminating direction thereof (vertical direction in FIG. 8), and the thus obtained laminated structure is sequentially further sandwiched between a pair of SUS plates 21A and 21B, a pair of SUS plates 22A and 22B and a pair of aramid cushions 23A and 23B to prepare a second laminate 9.

Herein, in the prepressing step, the second laminate 9 may be prepared in one step in the production of the second laminate 9 by collectively laminating the respective layers constituting the second laminate 9, besides a method in which a plurality of first laminates 8 are produced and then used to produce the second laminate 9 as described above.

Then, with the hot press apparatus 11, the second laminate 9 is heated and pressurized in the laminating direction thereof (vertical direction in FIG. 8), thereby being integrated. Thereby, the five laminated base materials 2 are simultaneously formed. The condition and the like of the hot pressing step can be the same as in Embodiment 1.

Then, the prepressing step is shifted to the heat treatment step, and the five laminated base materials 2 are heat-treated according to the same procedure as in Embodiment 1 described above.

Then, the heat treatment step is shifted to the main pressing step, and the five metallic foil laminate bodies 1, in which each laminated base material 2 is sandwiched between a pair of copper foils 3A and 3B to thereby be integrated, are produced according to the same procedure as in Embodiment 1 described above, as shown in FIG. 9. Namely, in the main pressing step, five third laminates 28, each in which the laminated base material 2 is sandwiched between the pair of copper foils 3A and 3B and a pair of spacer copper foils 5A and 5B, are prepared. Then, the five third laminates 28 are stacked via a partition plate (second partition material) 10 such as a SUS plate with a thickness of 1 mm interposed therebetween, in the laminating direction thereof (vertical direction in FIG. 9), and the thus obtained laminated structure is sequentially further sandwiched between the pair of SUS plates 21A and 21B, the pair of SUS plates 22A and 22B and the pair of aramid cushions 23A and 23B to prepare a fourth laminate 29. Thereafter, with the hot press apparatus 11, the fourth laminate 29 is heated and pressurized in the laminating direction thereof (vertical direction in FIG. 9), thereby being integrated. Thereby, the five metallic foil laminate bodies 1 are simultaneously formed.

Herein, also in the main pressing step, the fourth laminate 29 may be prepared in one step, not by previously forming a plurality of the third laminates 28 and then using them to prepare the fourth laminate 29, but by collectively laminating the respective layers constituting the fourth laminate 29.

Thus, the production procedure of the metallic foil laminate body 1 is completed, thereby obtaining the five metallic foil laminate bodies 1.

Since the five laminated base materials 2 are subjected to the prepressing step also in each metallic foil laminate body 1 thus obtained, it is possible to avoid the event that swelling occurs on the surfaces of the resin-impregnated base materials 2a in the moisture absorption solder heat resistance test for the same reasons as in Embodiment 1 described above, thereby making it possible to obtain the metallic foil laminate body 1 excellent in moisture absorption solder heat resistance.

### Embodiment 3

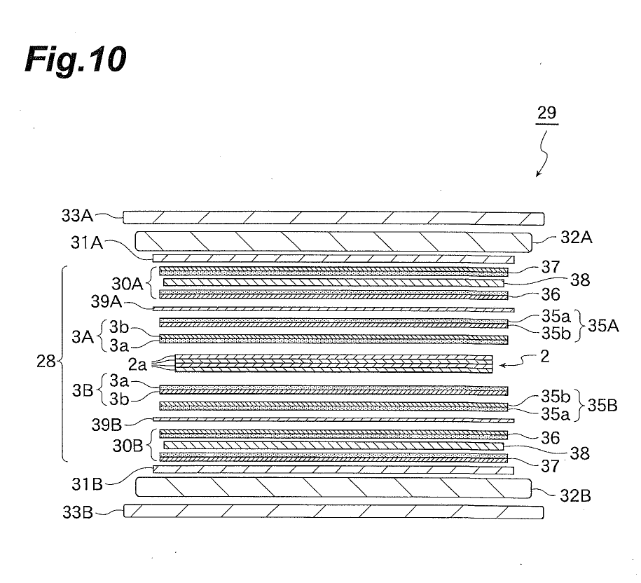

Embodiment 3 will be described with reference to FIG. 10. In Embodiment 3, a one-stage constitution, namely, a case where one metallic foil laminate body is produced by single hot pressing will be described. Herein, in FIG. 10, the respective members are illustrated with being separated from one another for easy understanding.

A metallic foil laminate body 1 and a hot press apparatus 11 according to Embodiment 3 each have the same constitution as in Embodiment 1 described above.

When the hot press apparatus 11 is used to produce the metallic foil laminate body 1, a metallic foil laminate body 1 is produced, as described below, according to the production procedure of the metallic foil laminate body 1 in Embodiment 1 described above.

First, in the prepressing step, a laminated base material 2, in which four resin-impregnated base materials 2a are laminated and integrated, is prepared according to the same procedure as in Embodiment 1 described above.

Then, the prepressing step is shifted to the heat treatment step, and the laminated base material 2 is heat-treated according to the same procedure as in Embodiment 1 described above.

Then, the heat treatment step is shifted to the main pressing step, and the metallic foil laminate body 1 in which the laminated base material 2 is sandwiched between a pair of copper foils 3A and 3B and they are integrated is produced according the same procedure in Embodiment 1 described above, as shown in FIG. 10.

In the main pressing step, a pair of spacer copper foils 35A and 35B, a pair of SUS foils 39A and 39B, a pair of hybrid cushion materials 30A and 30B, a pair of SUS plates each with a thickness of 1 mm, 31A and 31B, a pair of SUS plates each with a thickness of 5 mm, 32A and 32B, and a pair of aramid cushions each with a thickness of 3 mm, 33A and 33B, can be used as shown in FIG. 10. Herein, each spacer copper foil 35 is provided with a two-layered structure including a mat surface 35a and a shine surface 35b. Each hybrid cushion material 30 has a configuration in which a polytetrafluoroethylene sheet 38 is sandwiched between a pair of copper foils 36 and 37.

In the main pressing step, first, a third laminate 28 in which the laminated base material 2 is sequentially sandwiched between the pair of copper foils 3A and 3B, the pair of spacer copper foils 35A and 35B, the pair of SUS foils 39A and 39B and the pair of hybrid cushion materials 30A and 30B is prepared. Then, a fourth laminate 29 in which this third laminate 28 is sequentially sandwiched between the pair of SUS plates 31A and 31B, the pair of SUS plates 32A and 32B and the pair of aramid cushions 33A and 33B is prepared. Herein, the fourth laminate 29 may be prepared by collectively laminating the respective layers constituting the fourth laminate 29 without undergoing the preparation of the third laminate 28.

Thereafter, with the hot press apparatus 11, the fourth laminate 29 is heated and pressurized in the laminating direction thereof (vertical direction in FIG. 10), thereby being integrated. Thereby, the metallic foil laminate body 1 is formed. Thus, the production procedure of the metallic foil laminate body 1 is completed, thereby obtaining the metallic foil laminate body 1.

Since the laminated base material 2 is subjected to the prepressing step also in the metallic foil laminate body 1 thus obtained, it is possible to avoid the event that swelling occurs on the surfaces of the resin-impregnated base materials 2a in the moisture absorption solder heat resistance test for the same reasons as in Embodiment 1 described above. Thus, it is possible to obtain the metallic foil laminate body 1 excellent in moisture absorption solder heat resistance.

### Embodiment 4

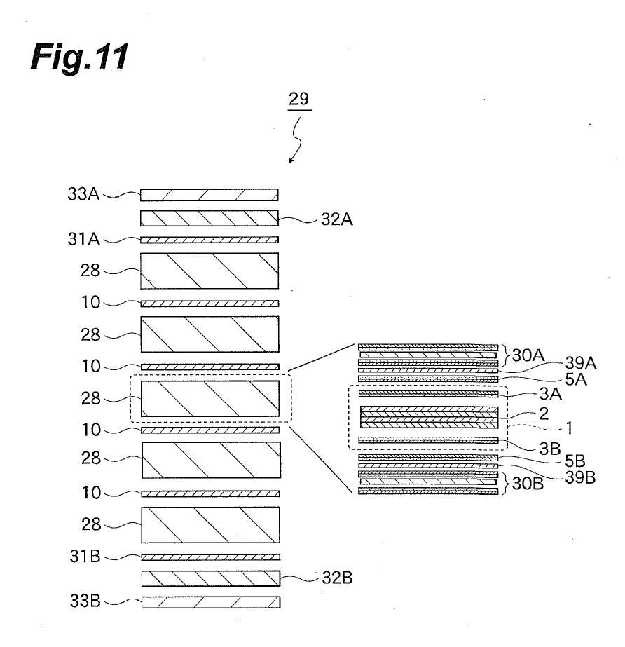

Embodiment 4 will be described with reference to FIG. 11. In Embodiment 4, a five-stage constitution, namely a case where five metallic foil laminate bodies are produced by single hot pressing will be described. Herein, in FIG. 11, the respective members are illustrated with being separated from one another for easy understanding.

A metallic foil laminate body 1 and a hot press apparatus 11 according to Embodiment 4 each have the same constitution as in Embodiment 1 described above.

When the hot press apparatus 11 is used to produce the metallic foil laminate body 1, five metallic foil laminate bodies 1 are simultaneously produced, as described below, according to the production procedure of the metallic foil laminate body 1 in Embodiment 3 described above.

First, in the prepressing step, five laminated base materials 2, each in which four resin-impregnated base materials 2a are laminated and integrated, are prepared according to the same procedure as in Embodiment 3 described above.

Then, the prepressing step is shifted to the heat treatment step, and the five laminated base materials 2 are heat-treated according to the same procedure as in Embodiment 3 described above.

Then, the heat treatment step is shifted to the main pressing step, and the five metallic foil laminate bodies 1, in which each laminated base material 2 is sandwiched between a pair of copper foils 3A and 3B and integrated, are produced according to the same procedure as in Embodiment 3 described above.

First, as shown in FIG. 11, the third laminate 28 formed in Embodiment 3, that is, five of the third laminates 28, in which each laminated base material 2 is sequentially sandwiched between a pair of copper foils 3A and 3B, a pair of spacer copper foils 5A and 5B, a pair of SUS foils 39A and 39B and a pair of hybrid cushion materials 30A and 30B are prepared. Then, the five third laminates 28 are stacked via a partition plate 10 such as a SUS plate with a thickness of 1 mm interposed therebetween, in the laminating direction thereof (vertical direction in FIG. 11), and the thus obtained laminated structure is sequentially further sandwiched between a pair of SUS plates 31A and 31B, a pair of SUS plates 32A and 32B and a pair of aramid cushions 33A and 33B to prepare a fourth laminate 29. Herein, the fourth laminate 29 may be prepared by collectively laminating the respective layers constituting the fourth laminate 29 without undergoing the preparation of the third laminate 28.

Thereafter, with the hot press apparatus 11, the fourth laminate 29 is heated and pressurized in the laminating direction thereof (vertical direction in FIG. 11), thereby being integrated. Thereby, the five metallic foil laminate bodies 1 are simultaneously formed. Thus, the production procedure of the metallic foil laminate body 1 is completed, thereby obtaining the five metallic foil laminate bodies 1.

Since the laminated base materials 2 are subjected to the prepressing step also in the metallic foil laminate body 1 thus obtained, it is possible to avoid the event that swelling occurs on the surfaces of the resin-impregnated base materials 2a in the moisture absorption solder heat resistance test for the same reasons as in Embodiment 1 described above, thereby making it possible to obtain the metallic foil laminate body 1 excellent in moisture absorption solder heat resistance.

### Other Embodiments

While the case of using the resin-impregnated base material 2a as the insulating base material has been described in Embodiments 1 to 4 described above, an insulating base material other than the resin-impregnated base material 2a (e.g., a resin film such as a liquid crystal polyester film or a polyimide film) can also be substituted therefor or used therewith.

While the case of using the polyimide film 20 as the mold release film has been described in Embodiments 1 to 4 described above, a mold release film other than the polyimide film 20 (e.g., a polyethersulfone film, a polyetherimide film, or a polysulfone film) in place of the polyimide film 20 can also be substituted therefor or used therewith.

While the case of using the SUS plates 21 and 22 as the metal plates has been described in Embodiments 1 and 2 described above, and the case of using the SUS plates 31 and 32 as the metal plates has been described in Embodiments 3 and 4 described above, one other than the SUS plates 21, 22, 31, and 32 (e.g., an aluminum plate) as the metal plate in place of these plates can also be substituted therefor or used therewith.

While the case of using the aramid cushion 23 as the cushion material has been described in Embodiments 1 and 2 described above, and the case of using the hybrid cushion material 30 and the aramid cushion 33 as the cushion materials has been described in Embodiments 3 and 4 described above, a cushion material other than aramid cushions 23 and 33, and the hybrid cushion material 30 (e.g., inorganic fiber nonwoven fabric cushions such as a carbon cushion or an alumina fiber nonwoven fabric cushion) in place of these cushions can also be substituted therefor or used therewith.

While the case of commonly using one hot press apparatus 11 when performing the prepressing step and the main pressing step has been described in Embodiments 1 to 4 described above, the prepressing step and the main pressing step can also be performed using the separate hot press apparatus 11.

While the case where the laminated base material 2 of the metallic foil laminate body 1 is constituted of the four resin-impregnated base materials 2a has been described in Embodiments 1 to 4 described above, there may be any number of the resin-impregnated base materials 2a for constituting the laminated base material 2 as long as the number is more than one (2 or more).

While the five-stage constitution has been described in the Embodiments 2 and 4 described above, multiple-stage constitution other than the five-stage constitution (e.g., two-stage constitution or three-stage constitution) can also be adopted.

### EXAMPLES

Hereinafter, the present invention will be described in more detail based on Examples, but the present invention is not limited to these Examples.

[Preparation of Resin-Impregnated Base Material]

Into a reactor equipped with a stirring apparatus, a torque meter, a nitrogen gas-introducing tube, a thermometer and a reflux condenser, 1976 g of 2-hydroxy-6-naphthoic acid (10.5 mol), 1474 g of 4-hydroxyacetoanilide (9.75 mol), 1620 g of isophthalic acid (9.75 mol) and 2374 g of acetic anhydride (23.25 mol) were charged. After sufficiently replacing the atmosphere in the reactor with a nitrogen gas, the temperature was raised to 150° C. over 15 minutes under a nitrogen gas flow and the resultant was refluxed for 3 hours with the temperature (150° C.) being maintained.

Thereafter, the temperature was raised to 300° C. over 170 minutes while distilling off acetic acid as a by-product and unreacted acetic anhydride distilled out, the point of time at which an increase in torque was recognized was regarded as the point of time at which the reaction had been completed, and then the content was taken out. The content was cooled to room temperature and ground by a grinder to obtain a powder of a liquid crystal polyester with a comparatively low molecular weight. The flow initiation temperature of this liquid crystal polyester powder was measured by a flow tester (“Model CFT-500”, manufactured by Shimadzu Corporation) and found to be 235° C. This liquid crystal polyester powder was subjected to a heat treatment under a nitrogen atmosphere at 223° C. for 3 hours to thereby perform solid phase polymerization. The flow initiation temperature of the liquid crystal polyester after the solid phase polymerization was 270° C.

The liquid crystal polyester thus obtained (2200 g) was added to 7800 g of N,N-dimethylacetamide (DMAc), and heated at 100° C. for 2 hours to obtain a liquid composition. The solution viscosity of this liquid composition was measured at a measuring temperature of 23° C. by using a B type viscometer (“Model TVL-20” (rotor No. 21; rotation rate: 5 rpm), manufactured by Toki Sangyo Co., Ltd.), and found to be 320 cP.

A glass cloth (45 μm in thickness, IPC name of 1078), manufactured by Arisawa Manufacturing Co., Ltd., was impregnated with the liquid composition thus obtained, and primarily dried by a hot-air type dryer at a set temperature of 160° C. to thereby prepare a resin-impregnated base material.

### Example 1

First, in the prepressing step, four sheets of the resin-impregnated base materials described above were prepared.

Then, an aramid cushion material (aramid cushion, 3 mm in thickness, manufactured by Ichikawa Techno-Fabrics Co., Ltd.), a SUS plate (SUS304, 5 mm in thickness), a polyimide film (polyimide film, 50 μm in thickness, manufactured by Junsei Chemical Co., Ltd.), the four resin-impregnated base materials, a polyimide film (polyimide film, 50 μm in thickness, manufactured by DU PONT-TORAY CO., LTD.), a SUS plate (SUS304, 5 mm in thickness), and an aramid cushion material (aramid cushion, 3 mm in thickness, manufactured by Ichikawa Techno-Fabrics Co., Ltd.) were laminated in this order from below. The obtained laminate was hot-pressed by using a high temperature vacuum press machine “KVHC-PRESS” (300 mm in length and 300 mm in width), manufactured by KITAGAWA SEIKI Co., Ltd., in the laminating direction thereof under the conditions of a temperature of 140° C. and a pressure of 5 MPa over 60 minutes, and thus the respective layers were integrated to obtain a laminated base material including the four resin-impregnated base materials.

Then, in the heat treatment step, the above obtained laminated base material was heat-treated by using a hot-air type dryer under a nitrogen atmosphere at 290° C. over 3 hours.

Then, in the main pressing step, the laminated base material after the heat treatment step was used to prepare a metallic foil laminate body. Namely, an aramid cushion material (aramid cushion, 3 mm in thickness, manufactured by Ichikawa Techno-Fabrics Co., Ltd.), a SUS plate (SUS304, 5 mm in thickness), a copper foil (“3EC-VLP”, 18 μm in thickness, manufactured by Mitsui Mining & Smelting Co., Ltd.), the above-described laminated base material, a copper foil (“3EC-VLP”, 18 μm in thickness, manufactured by Mitsui Mining & Smelting Co., Ltd.), a SUS plate (SUS304, 5 mm in thickness), and an aramid cushion material (aramid cushion, 3 mm in thickness, manufactured by Ichikawa Techno-Fabrics Co., Ltd.) were laminated in this order from below. The obtained laminate was hot-pressed by using a high temperature vacuum press machine “KVHC-PRESS” (300 mm in length and 300 mm in width), manufactured by KITAGAWA SEIKI Co., Ltd., in the laminating direction thereof under the conditions of a temperature of 340° C. and a pressure of 5 MPa over 30 minutes, and thus the respective layers were integrated to thereby obtain a metallic foil laminate body.

### Example 2

A metallic foil laminate body was produced by the same procedure as in Example 1 described above except that the temperature of hot pressing the four resin-impregnated base materials in the prepressing step was changed from 140° C. to 170° C.

Namely, first, in the prepressing step, four sheets of the four resin-impregnated base materials were first prepared. Then, an aramid cushion material (aramid cushion, 3 mm in thickness, manufactured by Ichikawa Techno-Fabrics Co., Ltd.), a SUS plate (SUS304, 5 mm in thickness), a polyimide film (polyimide film, 50 μm in thickness, manufactured by Junsei Chemical Co., Ltd.), the four resin-impregnated base materials, a polyimide film (polyimide film, 50 μm in thickness, manufactured by DU PONT-TORAY CO., LTD.), a SUS plate (SUS304, 5 mm in thickness), and an aramid cushion material (aramid cushion, 3 mm in thickness, manufactured by Ichikawa Techno-Fabrics Co., Ltd.) were laminated in this order from below. The obtained laminate was hot-pressed by using a high temperature vacuum press machine “KVHC-PRESS” (300 mm in length and 300 mm in width), manufactured by KITAGAWA SEIKI Co., Ltd., in the laminating direction thereof under the conditions of a temperature of 170° C. and a pressure of 5 MPa over 60 minutes, and thus integrated to obtain a laminated base material including the four resin-impregnated base materials.

Thereafter, a metallic foil laminate body was prepared in the heat treatment step by using a hot-air type dryer. Namely, the above obtained laminated base material was heat-treated under a nitrogen atmosphere at 290° C. over 3 hours.

Then, in the main pressing step, the laminated base material after the heat treatment step was used to prepare a metallic foil laminate body. Namely, an aramid cushion material (aramid cushion, 3 mm in thickness, manufactured by Ichikawa Techno-Fabrics Co., Ltd.), a SUS plate (SUS304, 5 mm in thickness), a copper foil (“3EC-VLP”, 18 μm in thickness, manufactured by Mitsui Mining & Smelting Co., Ltd.), the above-described laminated base material, a copper foil (“3EC-VLP”, 18 μm in thickness, manufactured by Mitsui Mining & Smelting Co., Ltd.), a SUS plate (SUS304, 5 mm in thickness), and an aramid cushion material (aramid cushion, 3 mm in thickness, manufactured by Ichikawa Techno-Fabrics Co., Ltd.) were laminated in this order from below. The obtained laminate was hot-pressed by using a high temperature vacuum press machine “KVHC-PRESS” (300 mm in length and 300 mm in width), manufactured by KITAGAWA SEIKI Co., Ltd., in the laminating direction thereof under the conditions of a temperature of 340° C. and a pressure of 5 MPa over 30 minutes, and integrated to thereby obtain a metallic foil laminate body.

### Comparative Example 1

A metallic foil laminate body was produced by the same procedure as in Example 1 described above except that the prepressing step was omitted.

Namely, four sheets of the resin-impregnated base materials were first prepared, each thereof was separately heat-treated one by one by using a hot-air type dryer under a nitrogen atmosphere at 290° C. over 3 hours, and then the heat-treated four resin-impregnated base materials were superposed to obtain a laminated base material.

Then, in the main pressing step, the laminated base material after the heat treatment step was used to prepare a metallic foil laminate body. Namely, an aramid cushion material (aramid cushion, 3 mm in thickness, manufactured by Ichikawa Techno-Fabrics Co., Ltd.), a SUS plate (SUS304, 5 mm in thickness), a copper foil (“3EC-VLP”, 18 μm in thickness, manufactured by Mitsui Mining & Smelting Co., Ltd.), the above-described laminated base material, a copper foil (“3EC-VLP”, 18 μm in thickness, manufactured by Mitsui Mining & Smelting Co., Ltd.), a SUS plate (SUS304, 5 mm in thickness), and an aramid cushion material (aramid cushion, 3 mm in thickness, manufactured by Ichikawa Techno-Fabrics Co., Ltd.) were laminated in this order from below. The obtained laminate was hot-pressed by using a high temperature vacuum press machine “KVHC-PRESS” (300 mm in length and 300 mm in width), manufactured by KITAGAWA SEIKI Co., Ltd., in the laminating direction thereof under the conditions of a temperature of 340° C. and a pressure of 5 MPa over 30 minutes, and integrated to thereby obtain a metallic foil laminate body.

### Comparative Example 2

A metallic foil laminate body was produced by the same procedure as in Example 1 described above except that one obtained by hot pressing only one resin-impregnated base material in place of simultaneously hot pressing four resin-impregnated base materials in the prepressing step was used as a base material.

Namely, one sheet of the resin-impregnated base material was first prepared in the prepressing step. Then, an aramid cushion material (aramid cushion, 3 mm in thickness, manufactured by Ichikawa Techno-Fabrics Co., Ltd.), a SUS plate (SUS304, 5 mm in thickness), a polyimide film (polyimide film, 50 μm in thickness, manufactured by Junsei Chemical Co., Ltd.), the one resin-impregnated base material, a polyimide film (polyimide film, 50 μm in thickness, manufactured by DU PONT-TORAY CO., LTD.), a SUS plate (SUS304, 5 mm in thickness), and an aramid cushion material (aramid cushion, 3 mm in thickness, manufactured by Ichikawa Techno-Fabrics Co., Ltd.) were laminated in this order from below. The obtained laminate was hot pressed by using a high temperature vacuum press machine “KVHC-PRESS” (300 mm in length and 300 mm in width), manufactured by KITAGAWA SEIKI Co., Ltd., in the laminating direction thereof under the conditions of a temperature of 140° C. and a pressure of 5 MPa over 60 minutes.

Thereafter, the resin-impregnated base material after the prepressing was heat-treated in the heat treatment step by using a hot-air type dryer under a nitrogen atmosphere at 290° C. over 3 hours.

Then, in the main pressing step, the resin-impregnated base material after the heat treatment was used to prepare a metallic foil laminate body. Namely, an aramid cushion material (aramid cushion, 3 mm in thickness, manufactured by Ichikawa Techno-Fabrics Co., Ltd.), a SUS plate (SUS304, 5 mm in thickness), a copper foil (“3EC-VLP”, 18 μm in thickness, manufactured by Mitsui Mining & Smelting Co., Ltd.), the heat-treated resin-impregnated base material, a copper foil (“3EC-VLP”, 18 μm in thickness, manufactured by Mitsui Mining & Smelting Co., Ltd.), a SUS plate (SUS304, 5 mm in thickness), and an aramid cushion material (aramid cushion, 3 mm in thickness, manufactured by Ichikawa Techno-Fabrics Co., Ltd.) were laminated in this order from below. The obtained laminate was hot pressed by using a high temperature vacuum press machine “KVHC-PRESS” (300 mm in length and 300 mm in width), manufactured by KITAGAWA SEIKI Co., Ltd., in the laminating direction thereof under the conditions of a temperature of 340° C. and a pressure of 5 MPa over 30 minutes, and integrated to thereby obtain a metallic foil laminate body.

### Comparative Example 3

A metallic foil laminate body was produced by the same procedure as in Comparative Example 2 described above except that the temperature of hot pressing the one resin-impregnated base material in the prepressing step was changed from 140° C. to 170° C.

Namely, in the prepressing step, one sheet of the resin-impregnated base material was first prepared. Then, an aramid cushion material (aramid cushion, 3 mm in thickness, manufactured by Ichikawa Techno-Fabrics Co., Ltd.), a SUS plate (SUS304, 5 mm in thickness), a polyimide film (polyimide film, 50 μm in thickness, manufactured by Junsei Chemical Co., Ltd.), the one resin-impregnated base material, a polyimide film (polyimide film, 50 μm in thickness, manufactured by DU PONT-TORAY CO., LTD.), a SUS plate (SUS304, 5 mm in thickness), and an aramid cushion material (aramid cushion, 3 mm in thickness, manufactured by Ichikawa Techno-Fabrics Co., Ltd.) were laminated in this order from below, and hot pressed by using a high temperature vacuum press machine “KVHC-PRESS” (300 mm in length and 300 mm in width), manufactured by KITAGAWA SEIKI Co., Ltd., under the conditions of a temperature of 170° C. and a pressure of 5 MPa over 60 minutes.

Thereafter, the prepressed resin-impregnated base material was heat-treated in the heat treatment step by using a hot-air type dryer under a nitrogen atmosphere at 290° C. over 3 hours.

Then, in the main pressing step, the heat-treated resin-impregnated base material was used, and an aramid cushion material (aramid cushion, 3 mm in thickness, manufactured by Ichikawa Techno-Fabrics Co., Ltd.), a SUS plate (SUS304, 5 mm in thickness), a copper foil (“3EC-VLP”, 18 μm in thickness, manufactured by Mitsui Mining & Smelting Co., Ltd.), the heat-treated resin-impregnated base material, a copper foil (“3EC-VLP”, 18 μm in thickness, manufactured by Mitsui Mining & Smelting Co., Ltd.), a SUS plate (SUS304, 5 mm in thickness) and an aramid cushion material (aramid cushion, 3 mm in thickness, manufactured by Ichikawa Techno-Fabrics Co., Ltd.) were laminated in this order from below. The obtained laminate was hot pressed by using a high temperature vacuum press machine “KVHC-PRESS” (300 mm in length and 300 mm in width), manufactured by KITAGAWA SEIKI Co., Ltd., in the laminating direction thereof under the conditions of a temperature of 340° C. and a pressure of 5 MPa over 30 minutes, and integrated to thereby obtain a metallic foil laminate body.

[Evaluation of Moisture Absorption Solder Heat Resistance]

Each of the metallic foil laminate bodies obtained in Examples 1 and 2 and Comparative Examples 1 to 3 was subjected to the moisture absorption solder heat resistance test. Namely, a test piece measuring 50 mm×50 mm was cut out from each metallic foil laminate body according to JIS C6481 (5.5), and a half of the copper foil thereof was removed by etching. Then, this test piece was left to stand over 2 hours in a thermostatic chamber at a temperature of 121° C., a relative humidity of 100% and an atmospheric pressure of 2 atm, and dipped in a solder bath at a temperature of 260° C. for only 30 seconds. Herein, the number of such test pieces with respect to each Example or Comparative Example was 3, respectively.

The presence or absence of swelling on the surface of the insulating base material was visually confirmed, the number of test piece(s) having swelling among the three test pieces with respect to each Example or Comparative Example was counted, and the result was used to evaluate moisture absorption solder heat resistance in each Example or Comparative Example. The obtained results are collectively shown in Table 1. In Table 1, the expression “1 ply×4” shown in the column of the prepressing condition means that each of the four resin-impregnated base materials used as the base material was separately prepressed one by one, and the expression “4ply” therein means that the four resin-impregnated base materials were prepressed in the state of being laminated to form a laminated base material.

TABLE 1

| | | | Solder dipping |
|---|---|---|---|
| | | Main pressing | Swollen sample |
| | Prepressing condition | condition | (n = 3) |
| Comparative | Not prepressing | 340° C.-5 MPa-30 min | 3 |
| Example 1 | | | |
| Comparative | 140° C.-5 MPa-60 min | | 3 |
| Example 2 | (1ply × 4) | | |
| Comparative | 170° C.-5 MPa-60 min | | 3 |
| Example 3 | (1ply × 4) | | |
| Example 1 | 140° C.-5 MPa-60 min | | 0 |
| | (4ply) | | |
| Example 2 | 170° C.-5 MPa-60 min | | 0 |
| | (4ply) | | |

As shown in Table 1, swelling was observed on the surfaces of the insulating base materials with respect to all the three test pieces in each of Comparative Examples 1 to 3. In contrast, no swelling was observed at all on the surfaces of the insulating base materials of all the three test pieces in each of Examples 1 and 2. It was demonstrated from these results that Examples 1 and 2 are more excellent in moisture absorption solder heat resistance than Comparative Examples 1 to 3.

### INDUSTRIAL APPLICABILITY

The method for producing a metallic foil laminate body of the present invention can be widely applied to the production of a metallic foil laminate body to be used as a material for a printed wiring board, and other application.

### REFERENCE SIGNS LIST

1 . . . metallic foil laminate body, 2 . . . laminated base material, 2a . . . resin-impregnated base material (insulating base material), 3 . . . copper foil (metal foil), 3a . . . mat surface, 3b . . . shine surface, 5 . . . spacer copper foil, 5a . . . mat surface, 5b . . . shine surface, 8 . . . first laminate, 9 . . . second laminate, 10 . . . partition plate, 11 . . . hot press apparatus, 12 . . . chamber, 13 . . . door, 15 . . . vacuum pump, 16 . . . upper hot platen, 16a . . . pressure surface, 17 . . . lower hot platen, 17a . . . pressure surface, 20 . . . polyimide film (mold release film), 21, 22 . . . SUS plate (metal plate), 23 . . . aramid cushion (cushion material), 28 . . . third laminate, 29 . . . fourth laminate, 30 . . . hybrid cushion material (cushion material), 31, 32 . . . SUS plate (metal plate), 33 . . . aramid cushion (cushion material), 35 . . . spacer copper foil, 35a . . . mat surface, 35b . . . shine surface, 36, 37 . . . copper foil, 38 . . . polytetrafluoroethylene sheet, 39 . . . SUS foil

1. A method for producing a metallic foil laminate body provided with a metal foil on both sides of a laminated base material including a plurality of insulating base materials, comprising:
a prepressing step of pressurizing and integrating a plurality of the insulating base materials in the state being laminated to thereby prepare the laminated base material;
a heat treatment step of heat-treating the laminated base material; and
a main pressing step of sandwiching the laminated base material between a pair of the metal foils, and heating, pressuring and integrating the laminated base material and the pair of the metal foils to thereby produce a metallic foil laminate body.

2. The method for producing a metallic foil laminate body according to claim 1, wherein the prepressing step and the main pressing step are carried out under reduced pressure.

3. The method for producing a metallic foil laminate body according to claim 1, wherein the prepressing step includes pressurizing the plurality of the insulating base materials sequentially sandwiched between a pair of mold release films, a pair of metal plates and a pair of cushion materials.

4. The method for producing a metallic foil laminate body according to claim 3, wherein the mold release film is a polyimide film.

5. The method for producing a metallic foil laminate body according to claim 3, wherein the metal plate is a SUS plate.

6. The method for producing a metallic foil laminate body according to claim 3, wherein the cushion material is an aramid cushion.

7. The method for producing a metallic foil laminate body according to claim 1, wherein the insulating base materials are resin-impregnated base materials in which an inorganic fiber or a carbon fiber is impregnated with a thermoplastic resin.

8. The method for producing a metallic foil laminate body according to claim 7, wherein the thermoplastic resin is a liquid crystal polyester having solubility in a solvent and a flow initiation temperature thereof is 250° C. or higher.

9. The method for producing a metallic foil laminate body according to claim 8, wherein the liquid crystal polyester is a liquid crystal polyester that has a structural unit represented by Formula (1), a structural unit represented by Formula (2) and a structural unit represented by Formula (3), wherein the content of the structural unit represented by Formula (1) is 30 to 45% by mole, the content of the structural unit represented by Formula (2) is 27.5 to 35% by mole, and the content of the structural unit represented by Formula (3) is 27.5 to 35% by mole, based on the total of all the structural units:
—O—Ar¹—CO— Formula (1)
—CO—Ar²—CO— Formula (2)
—X—Ar³—Y— Formula (3)
wherein Ar¹ represents a phenylene group or a naphthylene group, Ar² represents a phenylene group, a naphthylene group or a group represented by Formula (4), Ar³ represents a phenylene group or a group represented by Formula (4), and X and Y each independently represent O or NH, wherein hydrogen atoms bound to aromatic rings on Ar¹, Ar² and Ar³ may be substituted with halogen atoms, alkyl groups or aryl groups:
—Ar¹¹—Z—Ar¹²— Formula (4)
wherein Ar¹¹ and Ar¹² each independently represent a phenylene group or a naphthylene group, and Z represents O, CO or SO₂.

10. The method for producing a metallic foil laminate body according to claim 9, wherein at least one of X and Y in the structural unit shown by Formula (3) is NH.

11. The method for producing a metallic foil laminate body according to claim 8, wherein the liquid crystal polyester is a liquid crystal polyester in which the total content of a structural unit derived from p-hydroxybenzoic acid and a structural unit derived from 2-hydroxy-6-naphthoic acid is 30 to 45% by mole, the total content of a structural unit derived from terephthalic acid, a structural unit derived from isophthalic acid and a structural unit derived from 2,6-naphthalenedicarboxylic acid is 27.5 to 35% by mole, and the content of a structural unit derived from p-aminophenol is 27.5 to 35% by mole.

12. A method for producing a metallic foil laminate body provided with a metal foil on both sides of a laminated base material including a plurality of insulating base materials, comprising:
a prepressing step of pressurizing a first laminated structure, in which a plurality of first laminates each having a plurality of the insulating base materials laminated are stacked in a laminating direction so that at least a first partition material is placed between the first laminates, in the laminating direction thereof to thereby prepare a second laminate in which a plurality of the laminated base materials each having a plurality of the insulating base materials integrated are stacked via the first partition material interposed therebetween;
a heat treatment step of heat-treating the second laminate; and
a main pressing step of heating and pressurizing a second laminated structure, in which a plurality of third laminates each sandwiching the laminated base material after the heat treatment step with a pair of the metal foils are stacked in the laminating direction so that at least a second partition material is placed between the third laminates, in the laminating direction thereof to thereby produce a plurality of the metallic foil laminate bodies where the laminated base material is sandwiched between the pair of the metal foils and integrated.
